(19) United States
(12) Patent Application Publication
(10) Pub. No.: US 2020/0392320 A1
(43) Pub. Date: Dec. 17, 2020

(54) POLYPROPYLENE-BASED PARTICLES FOR ADDITIVE MANUFACTURING

(71) Applicant: 3D Systems, Inc., Rock Hill, SC (US)

(72) Inventors: Meisam Shir MOHAMMADI, Rock Hill, SC (US); Khalil MOUSSA, Rock Hill, SC (US)

(21) Appl. No.: 16/899,711

(22) Filed: Jun. 12, 2020

Related U.S. Application Data
(60) Provisional application No. 62/861,856, filed on Jun. 14, 2019.

(51) Int. Cl. C08L 23/14; B29C 64/153

(52) U.S. Cl. CPC C08L 23/142; B33Y 70/00; B29C 64/153

(57) ABSTRACT

Polypropylene-based powders are provided for use in the production of various articles by one or more additive manufacturing techniques. As described further herein, the polypropylene-based powders can exhibit particle morphologies, particle size distributions, and/or compositional parameters advantageous for production of articles having enhanced mechanical properties. In one aspect, a powder composition comprises particles of copolymer or terpolymer having a spherical shape, spheroidal shape, or a mixture of spherical and spheroidal shapes, the copolymer or terpolymer comprising one or more alkene monomeric species and the balance polypropylene.

### RELATED APPLICATION DATA

The present application claims priority pursuant to 35 U.S.C. § 119(e) to U.S. Provisional Patent Application Ser. No. 62/861,856 filed Jun. 14, 2019, which is incorporated herein by reference in its entirety.

### FIELD

The present invention relates to polymeric powders and, in particular, to polypropylene-based powders for use with one or more additive manufacturing techniques.

### BACKGROUND

Additive manufacturing generally encompasses processes in which digital 3-dimensional (3D) design data is employed to fabricate an article or component in layers by material deposition and processing. Various techniques have been developed falling under the umbrella of additive manufacturing. Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process and precluding the requirement of mold lubricants and coolant. Most importantly, additive manufacturing enables significant freedom in article design. Articles having highly complex shapes can be produced without significant expense allowing the development and evaluation of a series of article designs prior to final design selection.

### SUMMARY

Polypropylene-based powders are described herein for use in the production of various articles by one or more additive manufacturing techniques. The polypropylene-based powders can exhibit particle morphologies, particle size distributions, and/or compositional parameters advantageous for production of articles having enhanced mechanical properties. In one aspect, a powder composition comprises particles of copolymer or terpolymer having a spherical shape, spheroidal shape, or a mixture of spherical and spheroidal shapes, the copolymer or terpolymer comprising one or more alkene monomeric species and the balance polypropylene. In some embodiments, the alkene monomeric species is present in the copolymer or terpolymer in an amount of 3 to 9 molar percent. In some embodiments, the particles have an aspect ratio of 0.5-1. Moreover, the copolymer or terpolymer of the particles can have a random structure, including an isostatic random structure, and does not include formation of block copolymer or block terpolymer.

In another aspect, articles produced by an additive manufacturing technique are described. An article produced by an additive manufacturing technique comprises fused particles of copolymer or terpolymer comprising one or more alkene monomeric species and the balance polypropylene, wherein the article has a tensile strength of 18-23 MPa. In some embodiments, the article has an elongation at breakage greater than 70 percent.

In a further aspect, methods of forming articles are described. A method of forming an article comprises providing a powder composition including particles of copolymer or terpolymer having a spherical shape, spheroidal shape, or a mixture of spherical and spheroidal shapes, the copolymer or terpolymer comprising one or more alkene monomeric species and the balance polypropylene. The powder is formed into the article via an additive manufacturing technique. In some embodiments, the additive manufacturing technique is a powder bed fusion technique. The article can exhibit tensile strength of 18-23 MPa and/or elongation at breakage greater than 70 percent, in some embodiments.

These and other embodiments are further described in the following detailed description.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In one aspect, a powder composition comprises particles of copolymer or terpolymer having a spherical shape, spheroidal shape, or a mixture of spherical and spheroidal shapes, the copolymer or terpolymer comprising one or more alkene monomeric species and the balance polypropylene. In some embodiments, for example, the particles have an aspect ratio of 0.5-1. The spherical and/or spheroidal particles may also have an aspect ratio of 0.6-1, 0.7-1 or 0.8-1, in some embodiments.

The one or more alkene monomeric species of copolymer or terpolymer forming the particles, in some embodiments, can be selected according to various considerations including, but not limited to, altering the surface energies of the particles and/or polymer chain structure to promote particle coalescence in additive manufacturing techniques, including sintering. Any alkene monomeric species consistent with the objectives of enhancing one or more properties of articles produced by additive manufacturing can be employed. In some embodiments, for example, the alkene monomeric species for copolymerization with propylene monomer are selected from the group consisting of ethylene, butene and 1-octene. Any combination of alkene monomeric species with propylene monomer for particle formation is contemplated. In some embodiments, the copolymer or terpolymer of the particles has an isostatic random structure and does not include formation of block copolymer or block terpolymer. Additionally, the copolymer or terpolymer can be linear or substantially linear. In being substantially linear, the copolymer or terpolymer has less than 1 percent branching.

Copolymer and terpolymer can comprise any amount of alkene monomer consistent with the objectives described herein. In some embodiments, the alkene monomeric species are present in the copolymer or terpolymer in an amount of 1 to 20 molar percent. Alternatively, the alkene monomeric species can be present in the copolymer or terpolymer an amount selected from Table I.

TABLE I
Molar % of alkene monomeric species
2.5-15
3-9
4-10
2.5-6
3-5.5

Specific amounts of alkene monomer can be selected according to several considerations including, but not limited to, identity of the alkene monomeric species, desired copolymer or terpolymer structure, and/or particle surface energy. Moreover, the copolymer or terpolymer can have a M_{w}/Mₙ ratio of 1.2 to 5, in some embodiments.

Particles comprising copolymer or terpolymer described herein can exhibit various thermal properties and/or phase transition properties facilitating formation of articles with advantageous mechanical properties via additive manufacturing techniques, including powder bed fusion techniques. In some embodiments, copolymer or terpolymer of alklyene monomer and propylene forming the particles has a crystallization temperature less than 100° C. Crystallization temperature of the copolymer or terpolymer, for example, can range from 90-95° C. Additionally, in some embodiments, copolymer or terpolymer of the particles can exhibit a difference between melting temperature and crystallization temperature (Tₘ-T_{c}) of less than 45° C. or less than 40° C. In some embodiments, Tₘ-T_{c} ranges from 30-45° C. Melting and crystallization temperature of the copolymer and terpolymer can be determined according to differential scanning calorimetry (DSC).

In addition to copolymer or terpolymer composition and structure, the spherical and/or spheroidal particles of the powder may also exhibit particle size distributions yielding additive manufactured articles having enhanced mechanical properties. The particles, for example, can have a D10 of 20-40 μm. In some embodiments, the particles have a D10 of at least (0.6)D50 or at least (0.7)D50. D50 can range from 40-80 μm, in some embodiments. In conjunction with the foregoing D10 values, the particles can have a D90 of less than 150 μm or less than 120 μm. In some embodiments, less than 1 percent of the particles have size less than 10 μm.

In some embodiments, the powder composition has an apparent density of at least 0.4 g/cm³. Apparent density of the powder composition can be 0.4-0.6 g/cm³. The powder composition can also exhibit a tap density of at least 0.5 g/cm³. In some embodiments, the powder composition has a tap density of 0.45-0.65 g/cm³. Additionally, the ratio of tap density to apparent density (Hausner ratio) of powder composition is 1.1 to 1.4, in some embodiments. The Hausner ratio can be less than 1.25, such as 1.1-1.2, for example. Apparent density and tap density of powder compositions described herein can be determined according to ASTM D1895-17.

Powder compositions having the foregoing compositions and/or properties can be produced according to various techniques including, but not limited to, solvent precipitation, spray forming, and/or pulverization, milling and shaping.

As described herein, the foregoing properties of the powder composition can be advantageous for producing articles having enhanced mechanical properties via additive manufacturing techniques. An article manufactured by an additive manufacturing technique, for example, comprises fused particles of copolymer or terpolymer comprising the one or more alkene monomeric species and the balance polypropylene. In some embodiments, the additively manufactured article has a tensile strength of 17-25 MPa or 18-23 MPa. Additionally, the article can exhibit a tensile modulus of at least 700 MPa. The article, for example, can exhibit a tensile modulus of 700-1100 MPa. The article can also exhibit an elongation at break greater than 50 percent or greater than 70 percent according to ASTM D638. In some embodiments, the article exhibits an elongation at break of at least 90 percent. Elongation at break of the article can also range from 95-110 percent, in some embodiments. Additionally, the article can have a heat deflection temperature of 30-90° C.

Moreover, the article can have a notched impact strength greater than 35 J/m according to ASTM D256, in some embodiments. For example, the article can have a notched impact strength of 40 to 70 J/m. The article can also exhibit less than 5 vol.% porosity or less than 3 vol. % porosity, in some embodiments.

Enhancements to particle coalescence in the additive manufacturing process provided by the composition and properties of the copolymer or terpolymer described herein can assist in producing one or more of the foregoing mechanical properties of the article. The article can be manufactured by any desired additive manufacturing technique. In some embodiments, the article is manufactured by a powder bed technique, such as selective laser sintering (SLS) or selected laser melting (SLM). Table II provides a summary of the foregoing properties an article can exhibit when formed from powder compositions described herein via an additive manufacturing technique, according to some embodiments.

TABLE II
AM Article Properties

| Property | Value | |
|---|---|---|
| Tensile Strength | 18-25 | MPa |
| Tensile Modulus | 700-1100 | MPa |
| Elongation at break | 70 to >100% | |
| Notched impact strength | 35-70 | J/m |
| Porosity | <5 | vol. % |

In a further aspect, methods of forming articles are described. A method of forming an article comprises providing a powder composition including particles of copolymer or terpolymer, the copolymer or terpolymer comprising one or more alkene monomeric species and the balance polypropylene. The powder is formed into the article via an additive manufacturing technique. Powder compositions and the resultant articles of methods described herein can have any composition, architecture and/or properties described above, including the compositions and properties of Tables I and II. In some embodiments, the particles of copolymer or terpolymer have a spherical shape, spheroidal shape, or a mixture of spherical and spheroidal shapes. Alternatively, the particles of copolymer or terpolymer described herein are non-spherical or irregular shape, but exhibit bulk and/or tap density values disclosed above. Additionally, the additive manufacturing technique can be a powder bed technique, such as selective laser sintering (SLS) or selected laser melting (SLM).

These and other embodiments are further illustrated in the following examples.

### Example 1—Powder Composition

Random copolymer described herein comprising about 5 molar percent ethylene and the balance isotactic polypropylene was synthesized and formed into a powder composition via solvent pulverization. The random copolymer did not exhibit branching. The powder composition displayed the properties in Table III.

TABLE III
Copolymer Powder Properties

| Property | Value | |
|---|---|---|
| D10 | 26 | μm |
| D50 | 55 | μm |
| D90 | 110 | μm |
| T_{c} | 95° | C. |
| Tₘ | 129° | C. |

Individual copolymer particles exhibiting the properties of Table III had a spherical and/or spheroidal morphology.

### Example 2—Powder Composition

Random terpolymer described herein comprising about 3 molar percent ethylene, 3 molar percent butane, and the balance isotactic polypropylene was synthesized and formed into a powder composition via solvent pulverization. The terpolymer did not exhibit branching. The powder composition displayed the properties in Table IV.

TABLE IV
Terpolymer Powder Properties

| Property | Value | |
|---|---|---|
| D10 | 28 | μm |
| D50 | 62 | μm |
| D90 | 112 | μm |
| T_{c} | 95° | C. |
| Tₘ | 129° | C. |

Individual terpolymer particles exhibiting the properties of Table IV had a spherical and/or spheroidal morphology.

### Example 3—AM Articles

Tensile test bars and impact samples (notched and un-notched) were printed from powder compositions of Examples 1 and 2 on a sPro60 HD-HS SLS machine commercially available from 3D Systems of Rock Hill, S.C. Tensile test bars and impact samples were also printed from comparative powder compositions 3-5 on the sPro60 HD-HS SLS machine. Compositional parameters of comparative powder compositions were as follows:

Comparative powder 3—solvent pulverized isotatic polypropylene
Comparative powder 4—solvent pulverized block copolymer comprising 6-10 molar percent ethylene and the balance polypropylene
Comparative powder 5—solvent pulverized copolymer of less than 2 molar percent ethylene with the balance polypropylene
Additional parameters of Comparative powders 3-5 are provided in Table V.

TABLE V
Comparative powders 3-5

| | | | |
|---|---|---|---|
| | Comparative | Comparative | Comparative |
| Property | Powder 3 | Powder 4 | Powder 5 |

| | | | | | | |
|---|---|---|---|---|---|---|
| D10 | 23 | μm | 22 | μm | 25 | μm |
| D50 | 55 | μm | 52 | μm | 65 | μm |
| D90 | 112 | pm | 102 | μm | 115 | μm |
| T_{c} | 116° | C. | 115° | C. | 104° | C. |
| Tₘ | 166° | C. | 168° | C. | 150° | C. |

Comparative powders 3-5 exhibited a spherical and/or spheroidal morphology.

Print temperature and laser parameters of the sPro60 HD-HS SLS machine were optimized for each powder composition of Examples 1-2 and Comparative powders 3-5. Optimization was administered to achieve the highest mechanical properties for each printed article. All articles were printed in the XY plane and in accordance with the specifications set forth in the related ASTM. Results of the mechanical testing of the articles printed with each powder composition are provided in Table VI.

TABLE VI
Article Mechanical Properties

| Property | Ex. 1 | Ex. 2 | Comp. 3 | Comp. 4 | Comp. 5 |
|---|---|---|---|---|---|
| Tensile | 900 | 1000 | 1200 | 1000 | 850 |
| Modulus | | | | | |
| (MPa) | | | | | |
| Tensile | 20 | 21 | 12 | 12 | 16 |
| Strength | | | | | |
| (MPa) | | | | | |
| Elongation | >100 | >100 | 2 | 3 | 18 |
| at Breakage | | | | | |
| (%) | | | | | |
| Notched | 43 | 60 | 29 | 30 | 60 |
| Impact (J/m) | | | | | |

As provided in Table VI, the articles made from powder compositions described herein embodied in Examples 1 and 2 exhibited superior elongation at break, and impact and tensile strengths, while maintaining comparable tensile modulus values.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A powder composition comprising:
particles of copolymer or terpolymer having a spherical shape, spheroidal shape, or a mixture of spherical and spheroidal shapes, the copolymer or terpolymer comprising one or more alkene monomeric species in an amount of 3 to 9 molar percent, and the balance polypropylene.

2. The powder composition of claim 1, wherein the particles have an aspect ratio of 0.7 to 1.

3. The powder composition of claim 1, wherein the copolymer or terpolymer has a crystallization temperature less than 100° C.

4. The powder composition of claim 1, wherein a difference between melting temperature and crystallization temperature of the copolymer or terpolymer is less than 45° C.

5. The powder composition of claim 1, wherein the copolymer or terpolymer is not substantially branched.

6. The powder composition of claim 1, wherein the monomeric alkene species are selected from the group consisting of ethylene, butene and 1-octene.

7. The powder composition of claim 1, wherein the copolymer or terpolymer has an isotatic random structure.

8. The powder composition of claim 1, wherein the copolymer or terpolymer has M_{w}/Mₙ ratio of 1.2 to 5.

9. The powder composition of claim 1, wherein the particles have a D10 of at least (0.6)D50.

10. The powder composition of claim 9, wherein the particles have a D90 of less than 150 μm.

11. The powder composition of claim 1 having an apparent density greater than 0.4 g/cm³.

12. The powder composition of claim 1 having an apparent density of 0.4-0.6 g/cm³. 1 3. The powder composition of claim 1 having a tap density greater than 0.5 g/cm³.

14. The powder composition of claim 1 having a Hausner ratio of 1.1 to 1.4.

15. An article manufactured by an additive manufacturing technique comprising:
fused particles of copolymer or terpolymer comprising one or more alkene monomeric species and the balance polypropylene, wherein the article has a tensile strength of 18-23 MPa.

16. The article of claim 15, wherein the alkene monomeric species are present in the copolymer or terpolymer in an amount of 1 to 20 molar percent.

17. The article of claim 15, wherein the alkene monomeric species are present in the copolymer of terpolymer in an amount of 3 to 9 molar percent.

18. The article of claim 15, wherein the monomeric alkene species are selected from the group consisting of ethylene, butene and 1-octene.

19. The article of claim 15 having a tensile modulus of at least 700 MPa.

20. The article of claim 15 having an elongation at break greater than 70 percent according to ASTM D638.

21. The article of claim 15 having a notched impact strength greater than 40 J/m according to ASTM D256.

22. A method of forming an article comprising:
providing a powder composition including particles of copolymer or terpolymer having a spherical shape, spheroidal shape, or a mixture of spherical and spheroidal shapes, the copolymer or terpolymer comprising one or more alkene monomeric species and the balance polypropylene; and
forming the powder composition into the article via an additive manufacturing technique, wherein the article has a tensile strength greater than 18-23 MPa.

23. The method of claim 22, wherein the additive manufacturing technique is a powder bed fusion technique.

24. The method of claim 23, wherein the powder bed fusion technique is selective laser sintering or selective laser melting.

25. The method of claim 23, wherein the particles have an aspect ratio of 0.5 to 1.

26. The method of claim 23, wherein the alkene monomeric species are present in the copolymer or terpolymer in an amount of 3 to 9 molar percent.

27. The method of claim 23, wherein the monomeric alkene species are selected from the group consisting of ethylene, butene and 1-octene.

28. The method of claim 23, wherein the article has an elongation at break greater than 70 percent according to ASTM D638.

29. The method of claim 23, wherein the article has a notched impact strength greater than 40 J/m according to ASTM D256.

30. The method of claim 23, wherein the article has less than 5 vol. % porosity.

31. The method of claim 23, wherein the powder composition has an apparent density of 0.4-0.6 g/cm³.
